(19) United States
(12) Patent Application Publication
(10) Pub. No.: US 2008/0011399 A1
(43) Pub. Date: Jan. 17, 2008

(54) PNEUMATIC TIRE AND MANUFACTURING METHOD OF TIRE MOLD FOR MOLDING

(75) Inventor: Masaaki Ohara, Osaka-fu (JP)

Correspondence Address: FISH & RICHARDSON P.C., P.O. BOX 1022, MINNEAPOLIS, MN, 55440-1022, US

(73) Assignee: TOYO TIRE & RUBBER CO., LTD., Osaka-fu (JP)

(21) Appl. No.: 11/773,700

(22) Filed: Jul. 5, 2007

(30) Foreign Application Priority Data
Jul. 11, 2006 (JP) 2006-190008

(51) Int. Cl. B60C 11/03; B29C 33/38

(52) U.S. Cl. 152/209.2; 264/226

(57) ABSTRACT

When variable pitches are classified into a plurality of groups (S, M, and L) depending on lengths thereof in the tire circumferential direction, all the differences of the average pitch lengths of one of the groups and the average pitch lengths of the other groups are 3 to 30 mm and in at least one group of the groups, any one of the pitch of the group differs from the average pitch length (P_{M}) and among the differences of the average pitch lengths, when the minimum difference is defined to be Xₘᵢₙ, the pitch lengths of all the pitches of each group (M group) are modified to have the values of ±10% of the minimum difference is defined to be Xₘᵢₙ based on the average pitch length of the group.

The description of this application claims benefit of priority based on Japanese Patent Application No. 2006-190008, the entire same contents of which are incorporated by reference herein.

### BACKGROUND OF THE INVENTION

1. Field of the Invention

The present invention relates to a pneumatic tire with a tread pattern arranged that can improve noise and to a manufacturing method of a tire mold for forming said tread pattern. And in more detail, the present invention relates to a pneumatic tire with so-called variable pitches arranged in which the lengths of the pitches that are repetition units of the pattern in the tire circumferential direction are not constant and further, the present invention relates to a manufacturing method of the tire mold.

2. Description of the Prior Art

When the pneumatic tire rotates, noise is generated that has frequency corresponding to the pitch length of a tread pattern. When the tread pattern has the same pitch length, specific frequency components get remarkable, which causes peak level noise that is offensive to the ear.

For inhibiting this peak level noise, the method of inhibiting the offensive noise spreading into a plurality of frequency components by changing the pitch lengths is exemplified. Such kinds of pitch arrangements are called variable pitch arrangements. For example, the tire with variable pitch arrangements can be manufactured by the mold disclosed in Patent Document 1 (Unexamined Japanese Laid-Open Patent Publication No. Hei 10-305713).

An example of the tread pattern of the pneumatic tire with general variable pitch arrangement is shown in FIG. 3. FIG. 3 shows a part of the tread pattern (1) with three kinds of variable pitches (2) arranged, that is, the pitch length in the tire circumferential direction is represented as L_{S}<L_{M}<L_{L}. Such a pneumatic tire is manufactured by molding, using a tire mold for molding with the pattern formed that correspond to the tread pattern with variable pitch arrangements. Therefore, the cost for manufacturing the pneumatic tire with variable pitches arranged is directly affected by the cost for designing said tire mold for molding. Thus, from the view point of the cost for designing the tire mold for molding, methods of randomly arranging each pitch in the tire circumferential direction are employed with about three kinds of pitches of the different length S, M, and L or at most, about five kinds of pitches with the different length SS, S, M, L, and LL prepared.

When the pneumatic tire with such variable pitch arrangements is used, since the peak level noise that is concentrated on a specific frequency gets spread over some frequencies, human senses make us feel that the offensive noise gets reduced. If so, by employing the variable pitches with more finely varied pitch lengths by further increasing the kinds of pitches ignoring the cost for designing the tire mold for molding, the peak noise level can further be spread and so it may seem that the effect for preventing the noise is improved.

However, increasing the kinds of pitches is difficult to carry out from the view point of designing cost. Moreover, increasing the kinds of pitches and more finely setting the changes in pitch lengths makes the noise into white noise and since the overall noise (the noise amount integrated over all the frequency) increases here, human senses make us feel even more uncomfortable. In other words, since there is a problem of increasing the overall noise, by means of simply setting the changes in the pitch lengths more finely cannot solve the problem of reducing the uncomfortable noise.

### SUMMARY OF THE INVENTION

In order to solve the above mentioned problem, the present invention has its most important characteristics in that it relates to
a pneumatic tire provided with a tread pattern in which, when a minimum repetition unit of the block rows repeated in the tire circumferential direction is defined to be a pitch, said pitches can be classified into a plurality of groups with depending on the pitch lengths in the tire circumferential direction, wherein all the differences between the average pitch length of one of the groups and the average pitch lengths of other groups are within 3 to 30 mm,
at least in one group of said groups, the pitch length of any one of the pitches of said one group differs from the average pitch length of said one group, and when the minimum difference of the differences in said average pitch lengths is defined to be Xₘᵢₙ, the pitch lengths of all the pitches of said one group have the values within the range of ±10% of said minimum difference Xₘᵢₙ based on the average pitch length of said one group.

Further, the pneumatic tires that have the above mentioned characteristics can be manufactured efficiently by employing the efficient manufacturing method that has the main characteristics of comprising the steps of casting a plaster into a rubber mold, solidifying said plaster thereby making a plaster mold, followed by casting a metal into said plaster, solidifying said metal for manufacturing the pneumatic tire set forth in claim 1, wherein
in the process of smoothening a tread pattern of said tire mold for molding, the pattern lengths are modified only for the pattern that correspond to the pitch exceeding the range of ±10% of said minimum difference Xₘᵢₙ based on the average pitch length of said group.

Among the pneumatic tires with so-called variable pitch arrangements, in the pneumatic tires with the arrangements of the present invention, not only the uncomfortable noise of the peak level can further be reduced by the effect of the variable pitches, but also the increase in the overall noise can be inhibited without making the noise into white noise. By this, human senses make us feel that the degree of the offensive noise generated from the pneumatic tire of the present invention gets reduced compared with that of the conventional pneumatic tire.

In addition, since the mold for molding the pneumatic tire of the present invention with variable pitches arranged can be manufactured without greatly changing the manufacturing method of the conventional plaster molding methods, it can show the effect obtained by the present invention with so little extra designing cost for the molds for molding the tire, and so little cost for manufacturing the pneumatic tire of the present invention.

### BRIEF DESCRIPTION OF THE DRAWINGS

FIG. 1 is a virtual view for explanation in which the representative pitches of each pitch group are aligned from the left with the order of the pitch length in the tire circumferential direction.

FIG. 2 is a virtual view for explanation in which the four pitches belonging to the M pitch group of FIG. 1 are aligned from the left with the order of the pitch length in the tire circumferential direction.

FIG. 3 is a schematic view showing an example of the tread pattern that has variable pitch arrangements.

### DESCRIPTION OF THE PREFERRED EMBODIMENTS

Hereinafter, the explanation goes on for the pneumatic tire of the present invention and for simplifying the explanation, the pneumatic tires with variable pitch arrangements that can be classified into three kinds, that is, S pitch, M pitch, and L pitch are explained. Here, the word “pitch” described in the present specification means the same as the word that is generally used for explaining a so-called variable pitch in the technical field of pneumatic tires, however, in more detail, it means a minimum repetition unit of block rows repeated in the tire circumferential direction.

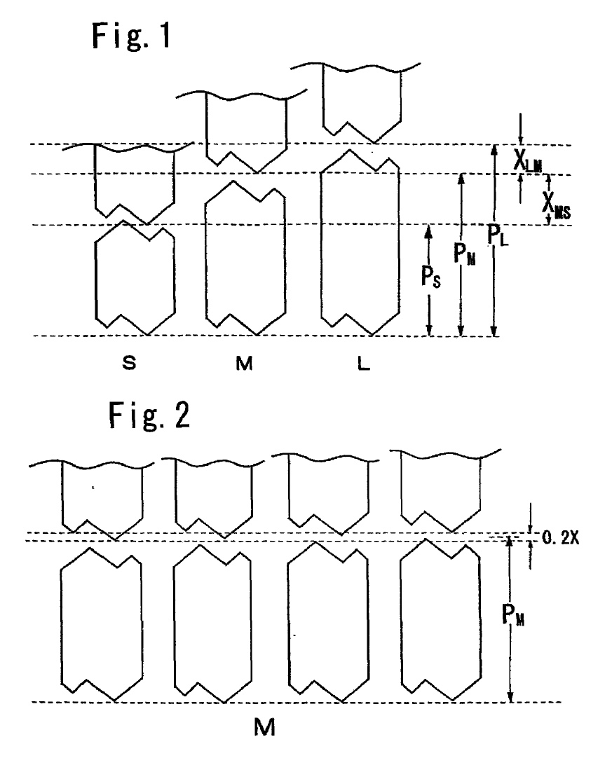

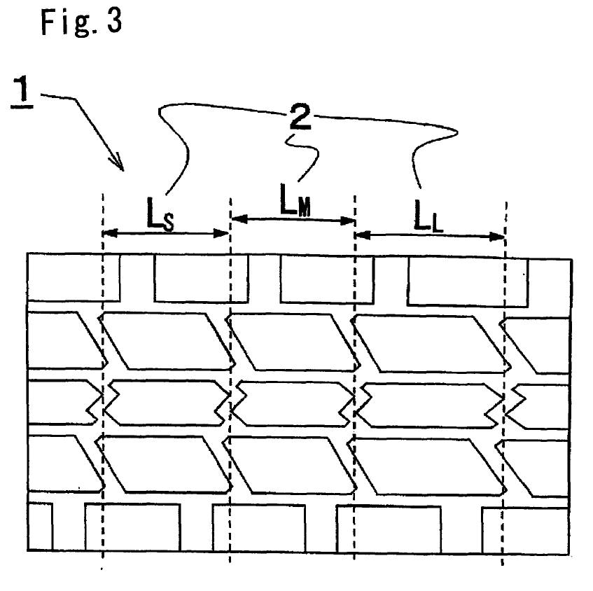

FIGS. 1 and 2 are virtual views for explanation aligning the pitches from the left with the order of the pitch length in the tire circumferential direction in order to clarify the difference from the conventional variable pitches and these drawings do not show the real tread pattern. In FIG. 1 the pitches with the average length of each pitch group are aligned from the left, S pitch, M pitch, and L pitch are shown. In FIG. 2 the four pitches of the M pitch group are aligned from the left with the order of pitch length.

In the ordinary variable pitches, the pitches of the same group have the same pitch lengths. However, in the variable pitch arrangements of the pneumatic tire of the present invention, the pitch lengths of the same group are not always the same, and therefore, consideration must be made based on the average pitch length (P) of each group.

As shown in FIG. 1, in the pneumatic tire of the present invention, the differences of the average pitch length of one group and the average pitch length of the other group, X_{MS}, X_{LM}, and X_{LS} (note: X_{LS} is not illustrated), are defined and all of the differences are within the range of 3 to 30 mm. In other words, it means that the difference of the nearest average pitch lengths of two groups is not less than 3 mm and that the difference of the maximum average pitch length and the minimum average pitch lengths is not greater than 30 mm. In variable pitch arrangements with the differences X of less than 3 mm, the noise generated from the tread pattern becomes white noise and the overall noise increases, and therefore, it is likely to make one who hears the noise feel uncomfortable. On the other hand, variable pitch arrangements with the differences X of exceeding 30 mm is not preferable, either, since it has a problem of appearance from the view point of design of the tread pattern and further, regarding the drainage and uneven wear property, the differences by each portion in the tire circumferential direction become too big.

As a specific example, calculation is hereby made under the condition of the average pitch length P_{S}=25 mm of the S pitch group, the average pitch length P_{M}=30 mm of the M pitch group, and the average pitch length P_{L}=33 =m of the L pitch group. The differences of the average pitch length between each of the groups are represented as X_{MS}=P_{M}−P_{S}=5 mm, X_{LM}=P_{L}−P_{M}=3 mm, and X_{LS}=P_{L}−P_{S}=8 mm. The difference of the nearest average pitch lengths of two groups (M pitch group and L pitch group) is X_{LM}=3 mm and the difference of the maximum and the minimum average pitch lengths is X_{LS}=8 mm. Therefore, all the differences between the average pitch length of one group and those of the other groups are within the range of 3 to 30 mm.

In addition, the pitches of the pneumatic tire of the present invention, the length of any one of the pitches of each group differs from the average pitch length of the group, and when the minimum difference of the average pitch lengths is defined to be Xₘᵢₙ, all the pitch lengths of each group is within the range of ±10% of the minimum difference Xₘᵢₙ based on the average pitch length of the group. When the pitch lengths of each group are varied out of the range of ±10% of the minimum difference Xₘᵢₙ of the average pitch length in the pitch group, the noise generated from the tread pattern becomes white noise and the overall noise increases, and therefore, it is likely to make one who hears the noise feel uncomfortable.

Further, in the present invention, the pitch lengths of all the pitches of each group do not have to be different from the average length of the group and it is enough that any one of the pitch length of the group is different from the average pitch length of the group. When a length of one pitch of each group is different from the average pitch length of the group, at least one pitch except said pitch has the different pitch length of the aforementioned average pitch length.

When explained specifically by using the same example as above, the minimum difference Xₘᵢₙ in the aforementioned average pitch lengths is represented as X_{LM}=3 mm, 10% of which being 0.3 mm, and therefore, the variation range of the pitch length of the pitches of the same group is calculated as 0.2Xₘᵢₙ=0.6 mm. Therefore, as shown in FIG. 2, in the M pitch group, at least two pitches whose lengths are not the average pitch length P_{M} of 30 mm are included and the pitch lengths of the M pitch group are varied within the range of −0.3 mm to +0.3 mm based on the average pitch length of the M pitch group P_{M}, that is, they are varied within the range of 29.7 mm to 30.3 mm.

In addition, as mentioned above, when at least one pitch group in which the pitch lengths are varied within the range of ±10% of the minimum difference Xₘᵢₙ based on the average pitch length of the group is present, the effect of the present invention can be developed. However, when the above mentioned relationship of being varied within the range of ±10% of the minimum difference Xₘᵢₙ is shared among all the pitch groups, it is further preferable, since the effect of the present invention can more remarkably be developed. In other words, it is preferable that the pitches of not only the M group but also the S group and the L group have the same variation relationship.

(Manufacturing Method of the Tire Mold for Molding)

In order to manufacture the pneumatic tires with variable pitch arrangements of the present invention, the problem is that how we should form the pattern that correspond to the variable pitch arrangements of the present invention on the tire mold for molding.

As a method of forming a pattern on a tire mold for molding, when the method of directly forming the pattern on the mold using numerically controlled machine tools are employed, in conventional variable pitch arrangements programming for three pitches S pitch, M pitch, and L pitch is needed. In the present invention, in accordance with a plan with different pitch lengths with a variation of ±10% of the minimum difference Xₘᵢₙ even in the same group, programming for all the pitches is needed. However, since the kinds of programming extremely increase with this method, the designing cost for the tire mold for molding increases compared with the designing cost for the usual variable pitches.

However, when conventionally used plaster molding methods are applied, the tire mold for molding with the pattern that correspond to variable pitch arrangements used in the present invention provided “stochastically” can effectively be manufactured. In the plaster molding methods, generally, a rubber mold that has a reverse pattern of the tread pattern is manufactured first, and by casting the plaster therein, the plaster mold is manufactured. And by casting metals such as aluminum and the like in this plaster mold, the tire mold for molding is manufactured.

These processes of manufacturing the plaster molds and of manufacturing the tire mold for molding comprise the step of solidifying fluidized plasters and metals such as aluminum and the like. In this step of solidifying the plasters and the metals, plaster molds or the tire molds for molding are contracted. At this time, the pattern provided in the plaster molds or the tire molds for molding are not always contracted evenly and a certain variation in length is sure to be generated. In general, in order to correct this variation, the pattern lengths are modified at the time of surface-machining the pattern by grinding some portion of the pattern as well.

In the tire mold for molding used in the present invention, by positively utilizing the variation, the tire mold for molding with the pattern that correspond to the variable pitch arrangements “stochastically” formed and used in the present invention can effectively be manufactured. In other words, in surface-machining the pattern, in principle, only the surface-machining is conducted without modifying the lengths and by modifying the pitch length switch regard only to the pattern portions that correspond to the pitches that vary exceeding ±10% of the minimum difference Xₘᵢₙ, the tire mold for molding of the present invention with pattern formed corresponding to the variable pitch arrangements used in the present invention can be prepared.

What is claimed is:

1. A pneumatic tire provided with a tread pattern in which, when a minimum repetition unit of the block rows repeated in the tire circumferential direction is defined to be a pitch, said pitches can be classified into a plurality of groups with depending on the pitch lengths in the tire circumferential direction, wherein
all the differences between the average pitch length of one of the groups and the average pitch lengths of other groups are within 3 to 30 mm,
at least in one group of said groups, the pitch length of any one of the pitches of said one group differs from the average pitch length of said one group, and when the minimum difference of the differences in said average pitch lengths is defined to be Xₘᵢₙ, the pitch lengths of all the pitches of said one group have the values within the range of ±10% of said minimum difference Xₘᵢₙ based on the average pitch length of said one group.

2. A manufacturing method comprising the steps of casting a plaster into a rubber mold, solidifying said plaster thereby making a plaster mold, followed by casting a metal into said plaster, solidifying said metal for manufacturing the pneumatic tire set forth in claim 1, wherein
in the process of smoothening a tread pattern of said tire mold for molding, the pattern lengths are modified only for the pattern that correspond to the pitch exceeding the range of ±10% of said minimum difference Xₘᵢₙ based on the average pitch length of said group.
